(19) United States
(12) Patent Application Publication
(10) Pub. No.: US 2025/0046112 A1
(43) Pub. Date: Feb. 6, 2025

(54) SYSTEMS AND METHODS FOR AUTOMATIC INTERPRETATION OF DOG EMOTION USING MACHINE LEARNING

(71) Applicant: Mars, Incorporated, McLean, VA (US)

(72) Inventors: Hannah FLINT, Oakham (GB); Tammie KING, Melton Mowbray (GB); André DOURSON, La Wantzenau (FR); Prateek DHAWALIA, Bangalore (IN); Nina ROMANOVA, Jersey City, NJ (US)

(21) Appl. No.: 18/787,302

(22) Filed: Jul. 29, 2024

Related U.S. Application Data
(60) Provisional application No. 63/516,586, filed on Jul. 31, 2023.

(51) Int. Cl. G06V 40/10; G06T 5/30; G06V 10/764; G06V 10/82

(52) U.S. Cl. CPC G06V 40/103; G06T 5/30; G06V 10/764; G06V 10/82

(57) ABSTRACT

A computer-implemented method for detecting one or more emotions of one or more pets is disclosed. The method receiving, by one or more processors, image data from at least one user device, wherein the image data includes one or more frames, detecting, by the one or more processors, at least one pet outline that includes at least one pet in the one or more frames, detecting, by the one or more processors, one or more emotions of the at least one pet based on the at least one pet outline; and displaying, by the one or more processors, the one or more emotions on at least one user interface of a user device.

### CROSS-REFERENCE TO RELATED APPLICATION(S)

This patent application is a continuation of and claims the benefit of priority to U.S. Application No. 63/516,586, filed on Jul. 31, 2023, the entirety of which is incorporated herein by reference.

### TECHNICAL FIELD

Various embodiments of this disclosure relate generally to detecting one or more emotions of one or more pets. In some embodiments, the disclosure relates to systems and methods for using a machine-learning model to detect one or more emotions of one or more pets based on one or more videos.

### BACKGROUND

Pets express their emotions in ways that are different from humans. Pet owners may desire to understand how their pet may be feeling, in order to determine whether lifestyle adjustments may be needed to change their pet's emotions. Additionally, pet owners may desire to understand how their pet physically shows emotions, in order to read how their pet feels in particular situations. For example, a pet owner may desire to know when their pet feels scared, in order to help the pet feel safer and prevent harm to others. Additionally, a pet owner may desire to know their pet's emotional state in order to determine when to seek veterinary support for their pet's illness or injury. A pet owner may find evaluating the pet's physical traits to determine the pet's emotions to be incredibly challenging, as the pet owner may not understand which physical traits to evaluate. Moreover, a pet owner may be unfamiliar with the behaviors and indicators that reflect a pet's emotions, resulting in the pet owner's inability to properly assess how the pet may be feeling.

Conventional methods may include the pet owner evaluating characteristics of the pet and determining the pet's emotions based on such characteristics. However, such conventional methods may be challenging for a pet owner, as the pet owner may not know which pet characteristics to evaluate. Conventional methods may not take the pet's breed into account when analyzing the pet's characteristics. Additionally, many pet owners also lack experience, pet behavior expertise, and breed-specific knowledge when analyzing a pet's characteristics to determine the pet's emotions.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for detecting one or more emotions of one or more pets.

In one aspect, an exemplary embodiment of a method for detecting an emotion of one or more pets is disclosed. The method may include receiving, by one or more processors, image data from at least one user device, wherein the image data includes one or more frames. The method may include detecting, by the one or more processors, at least one pet outline that includes at least one pet in the one or more frames. The method may include detecting, by the one or more processors, one or more emotions of the at least one pet based on the at least one pet outline. The method may include displaying, by the one or more processors, the one or more emotions on at least one user interface of a user device.

In a further aspect, an exemplary embodiment of a computer system for detecting an emotion of one or more pets is disclosed, the computer system comprising at least one memory storing instructions, and at least one processor configured to execute the instructions to perform operations. The operations may include receiving image data from at least one user device, wherein the image data includes one or more frames. The operations may include detecting at least one pet outline that includes at least one pet in the one or more frames. The operations may include detecting one or more emotions of the at least one pet based on the at least one pet outline. The operations may include displaying one or more emotions on at least one user interface of a user device.

In a further aspect, a non-transitory computer-readable medium storing instructions that, when executed by a processor, cause the processor to perform operations for detecting an emotion of one or more pets is disclosed. The operations may include receiving image data from at least one user device, wherein the image data includes one or more frames. The operations may include detecting at least one pet outline that includes at least one pet in the one or more frames. The operations may include detecting one or more emotions of the at least one pet based on the at least one pet outline. The operations may include displaying one or more emotions on at least one user interface of a user device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a flowchart of an exemplary embodiment for detecting an emotion of one or more pets, according to one or more embodiments.

FIGS. 2A-2C depict an example interface for analyzing pet image data to determine an emotion, according to one or more embodiments.

FIG. 3 depicts an exemplary environment that may be utilized with techniques presented herein, according to one or more embodiments.

FIG. 4 depicts an example of a computing device that may execute the techniques described herein, according to one or more embodiments.

### DETAILED DESCRIPTION OF EMBODIMENTS

According to certain aspects of the disclosure, methods and systems are disclosed for detecting emotions of one or more pets. Conventional techniques may not be suitable because conventional techniques may rely on the pet owner evaluating characteristics of the pet and determining the pet's emotions based on such characteristics. Additionally, conventional techniques may not take the pet's breed type and morphology into account when analyzing the pet's characteristics. Accordingly, improvements in technology relating to detecting a pet's emotions are needed.

In order to improve their pet's emotional well-being, pet owners may need to first be able to accurately identify their pet's emotional state. However, pet owners may not be able to accurately identify different pet behaviors, or may interpret behavior differently based on their previous experiences or relationship with the individual, pet, or other pets. While owners may be able to recognize more extreme emotional responses, owners may not be as successful in recognizing more subtle responses, such as mild fear and stress. Additionally, different experiences, such as receiving training in pet behavior, having different pet-related occupations, growing up with pets, or growing up in cultures with different views on pets have been shown to impact how people rate pet emotions. The implications of pet caregivers not being able to accurately interpret a range of both extreme and subtle pet emotional states may result in compromised pet welfare and an increased risk of negative human-pet interactions. These events may damage the human-pet bond and lead to possible pet relinquishment. To optimize pet welfare and enrich the quality of human-animal interactions, it is necessary to provide services whereby pet owners can learn to accurately assess how their pet may be feeling and empower them to respond appropriately. In support of this goal, a model that can automatically recognize pet emotional states from image data (e.g., video footage) would be beneficial. This would allow pet owner's to gain additional information on how their pet feels about different situations or interventions, informing decisions about appropriate actions on whether to continue or intervene, as well as to gauge changes over time in how their pet responds. This may include both positive situations where the pet owner or caregiver is looking to understand the pet's level of enjoyment (e.g., giving different food/treats), as well as potentially negative situations that may result in the pet becoming stressed (e.g., grooming or interactions with strangers).

Automatic recognition of pet emotional states from video footage may be beneficial in a number of other settings. Assessment of pet behavior and emotions for research purposes is traditionally conducted through manual coding of behaviors from video footage. Manual coding of behaviors from video requires a large amount of human resources, and risks reduction in data quality due to poor coder training, or coder fatigue. Automation of emotion recognition may allow for monitoring of pet emotional wellbeing at a large scale, and/or in the absence of human observers. For example, in combination with installation of video surveillance equipment, such a model would allow for reliable assessment and monitoring of pet emotional wellbeing in settings, such as veterinary clinics and hospitals, shelters, boarding kennels, day care centers, research facilities, or home environments when the owner is not present. This could allow for identification of pets at risk for reduced wellbeing, and for the implementation of early interventions to address concerns. Further, such a model may improve the feasibility of research aimed to better understand the current state of pet emotional wellbeing and the effect of different interventions.

Thus, a need exists for techniques that analyze a pet's attributes (e.g., movement, posture) to determine the pet's emotions. The techniques disclosed herein may analyze a pet's image data to determine the pet's emotions. Such techniques may also include analyzing the pet's breed, which may result in a more accurate determination of the pet's emotions. Moreover, the techniques may utilize a machine-learning model when performing the analysis, resulting in increased accuracy and efficiency.

As will be discussed in more detail below, in various embodiments, systems and methods are described for receiving image data from at least one user device, where the image data includes one or more frames. The systems and methods may include detecting at least one pet outline that includes at least one pet in the one or more frames. The systems and methods may include detecting one or more emotions of the at least one pet based on the at least one pet outline. The systems and methods may include displaying the one or more emotions on at least one user interface of a user device.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

As used herein, a term such as “user” or the like generally encompasses a future pet owner, caregiver, future pet owners, pet owner, and/or pet owners. A term such as “pet” or the like generally encompasses a domestic animal, such as a domestic canine, feline, rabbit, ferret, horse, cow, or the like. In exemplary embodiments, “pet” may refer to a canine.

Additionally, the techniques below may be applied to monitoring dog well-being in shelters, veterinary clinics, grooming establishments, boarding kennels, dog day cares, and/or research facilities using video surveillance equipment. Additionally, an automated model may support the quantification of pet emotion for research purposes. For example, an automated model may allow for the assessment of pet emotional well-being, as well as assessing the impact of different interventions.

### Exemplary Method for Detecting an Emotion of One or More Pets

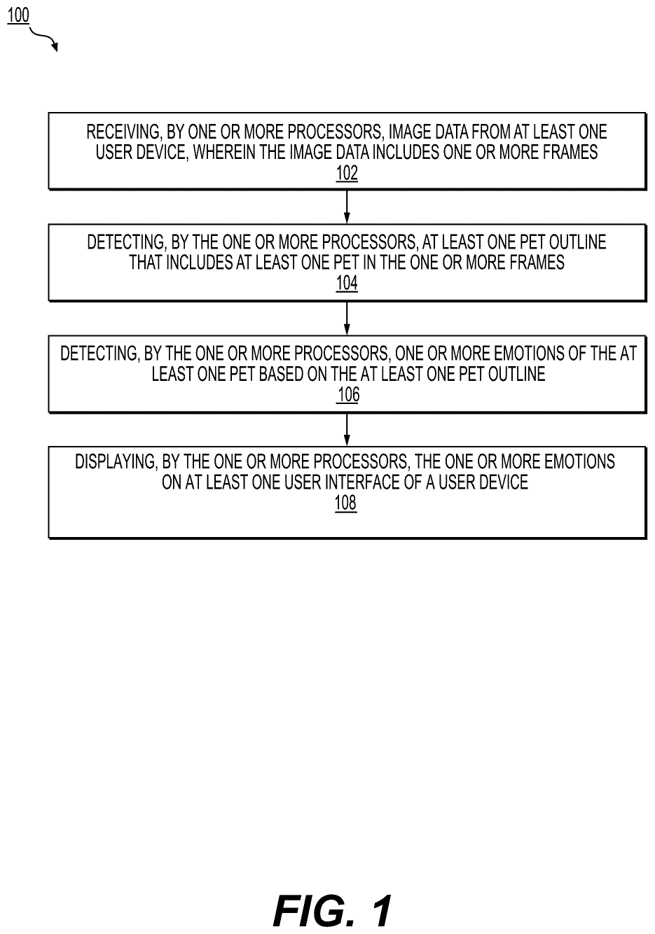

FIG. 1 illustrates an exemplary method 100 for detecting one or more emotions of one or more pets, according to one or more embodiments. Notably, method 100 may be performed by one or more processors of a server that is in communication with one or more user devices and other external system(s) via a network. However, it should be noted that method 100 may be performed by any one or more of the server, one or more user devices, or other external systems.

The method may include receiving, by one or more processors, image data from at least one user device, wherein the image data includes one or more frames (Step 102). The one or more frames may correspond to one or more still images of the image data. In some embodiments, the image data may include video data. In some embodiments, the video data may have a duration of a threshold amount. For example, the threshold amount may be 5 seconds, where a video may have a maximum length of 5 seconds. Additionally, for example, the one or more frames may include clips of the video data for a period of time (e.g., 5 second clips). The image data may include at least one video of a pet, where the one or more frames may correspond to one or more still images of the video. The image data may also include one or more pixels. The user device may have captured and/or stored the image data. For example, a user (e.g., pet owner) may utilize the user device to record one or more videos of the pet. In some embodiments, the image data may have been collected and/or stored by one or more mobile applications. In some embodiments, the image data may include more than one video clip. Additionally, or alternatively, at least one data store may store the image data.

In some embodiments, the method may include receiving, pet data from one or more devices. For example, the one or more devices may include sensors, wearables, thermometers, medical devices, accelerometers, and the like. Additionally, for example, the pet data may include vocalizations, heart rate, heart rate variability, skin temperature, and activity data of the pet. In some embodiments, the pet data may include time stamps to indicate when the pet data occurred.

The method may include detecting, by the one or more processors, at least one pet outline that includes at least one pet in the one or more frames (Step 104). In some embodiments, a convolutional neural network (CNN) model may be trained to detect an outline of at least one pet. The pet outline may include part of a pet (e.g., a paw) or the whole pet (e.g., the whole body of a dog). In some embodiments, each frame of the image data may be analyzed to detect at least one pet outline. However, not all frames may include a pet outline. In some embodiments, a frame may include two pets, where the pet outline may include one of the two pets. The other pet may be considered part of the background of the frame.

The method may include identifying, by the one or more processors, at least one mask corresponding to a background around the at least one pet outline of the one or more frames. For example, the pet outline may outline a pet in the frame, where the outline may occur at a specified distance from the pet image (e.g., 2 millimeters from the pet). The mask may correspond to the background, where everything in the frame, except for the pet outline, may be included in the mask. The method may further include updating, by the one or more processors, the one or more frames, the updating includes utilizing the at least one mask to neutralize the background from the one or more frames. The mask may be used to remove the original background of the frame. For example, the mask may be used to add color (e.g., the same color) to each pixel of the background, resulting in neutralizing the background and isolating the pet outline. The method may further include creating, by the one or more processors, new image data based on the one or more updated frames. For example, the new image data may include the frames with the background removed from the frame. The new image data may include a movie of the frames, where the movie has isolated a pet from the received image data. In some embodiments, each pet in the image data may have corresponding new image data, where the new image data may include an isolated pet. For example, the received image data may include a video with three dogs running. The new image data may include three separate videos, where each video may correspond to one of the dogs. The method may further include annotating such new image data. For example, a video with the masked background may include annotations indicating the pet's particular behavior and/or emotion(s).

The method may include dilating, by the one or more processors, the at least one pet outline to maximize coverage of the at least one pet outline. For example, dilating the pet outline may include expanding the pet outline by one or more pixels and including some pixels from the background as part of the pet outline. Additionally, dilating the pet outline may result in handling model errors and/or maximizing coverage of the pet outline.

The method may include detecting, by the one or more processors, one or more emotions of the at least one pet based on the at least one pet outline (Step 106). The one or more emotions may include happy, sad, frustrated, curious, afraid or anxious, aggressive and afraid, aggressive without fear, predatory, and conflicted. In some embodiments, the detecting may be based on the received pet data. In some embodiments, the detecting may be performed by one or more trained machine-learning models. In some embodiments, the detecting may include receiving, by a trained machine-learning model, the at least one pet outline. For example, the machine-learning model may receive the at least one pet outline as input. In some embodiments, the trained machine-learning model may also receive the pet data. The trained machine-learning model may have been previously trained to learn the relationships between the pet in the pet outlines and one or more pet emotions. Upon receiving the at least one pet outline and/or the pet data, the trained machine-learning model may determine the one or more emotions. Additionally, in some embodiments, training the machine-learning model may include receiving training data, such as one or more training pet outlines and one or more training pet emotions. The machine-learning model may then analyze the training data to determine and store one or more relationships between the pet in the pet outlines and the one or more emotions.

In some embodiments, the method may include classifying, by the one or more processors, the at least one pet included in the at least one pet outline as corresponding to at least one pet breed. The at least one pet breed may correspond to a breed of the pet. For example, the pet breed may include Afghan Hound, Airedale, Akita, Alaskan Malamute, Basset Hound, Beagle, Belgian Shepherd, Bloodhound, Border Collie, Border Terrier, Borzoi, Boxer, Bulldog, Bull Terrier, Cairn Terrier, Chihuahua, Chow, Cocker Spaniel, Collie, Corgi, Dachshund, Dalmatian, Doberman, English Setter, Fox Terrier, German Shepherd, Golden Retriever, Great Dane, Greyhound, Griffon Bruxellois, Irish Setter, Irish Wolfhound, King Charles Spaniel, Labrador Retriever, lhasa Apso, Mastiff, Newfoundland, Old English Sheepdog, Papillion, Pekingese, Pointer, Pomeranian, Poodle, Pug, Rottweiler, St. Bernard, Saluki, Samoyed, Schnauzer, Scottish Terrier, Shetland Sheepdog, Shih Tzu, Siberian Husky, Skye Terrier, Springer Spaniel, West Highland White Terrier, Yorkshire Terrier, cross-breeds, and the like.

In some embodiments, the classifying may be performed by one or more trained machine-learning models. In some embodiments, the classifying may include receiving, by a trained machine-learning model, the at least one pet outline. For example, the machine-learning model may receive the at least one pet outline as input. The trained machine-learning models may include a breed classifier. The trained machine-learning model may receive and process the at least one pet outline to determine the at least one pet breed. The classifying may include analyzing, by the trained machine-learning model, the at least one pet outline to determine at least one physical feature (e.g., posture) of the at least one pet. For example, the trained machine-learning model may have been previously trained to learn the relationships between the pet in the pet outlines and pet breeds. The classifying may include determining, by the trained machine-learning model, based on the at least one physical feature, that the at least one pet corresponds to the at least one pet breed. The physical feature may correspond to a physical attribute of the breed (e.g., short legs), the movement of the breed (e.g., a wide gait), and/or the posture of the breed. For example, the trained machine-learning model may have been trained to associate a pet with short legs and a short gait as a Dachshund.

In some embodiments, the method may include analyzing, by the one or more processors, the at least one pet outline in each of the one or more frames. For example, a trained machine-learning model may repeat the process described above for each of the frames. The method may also include determining, by the one or more processors, that the at least one pet breed occurs a maximum amount of times in the one or more frames. The classification for each of the pet outlines may be analyzed, where the classification that occurred a maximum amount of times may be determined as the pet breed. For example, the image data may include 10 frames, where the trained machine-learning model may have classified the pet outlines in 6 frames as a Golden Retriever and the pet outlines in 4 frames as a Labrador Retriever. As a result, the pet may be classified as a Golden Retriever because the Golden Retriever classification occurred the most times.

Additionally, or alternatively, in some embodiments, training the machine-learning model may include receiving training data, such as one or more training pet outlines and one or more corresponding training pet breeds. The machine-learning model may then analyze the training data to determine and store one or more relationships between the pet in the pet outlines and the pet breeds.

In some embodiments, the method may include associating, by the one or more processors, the at least one pet breed with at least one breed cluster, wherein each of the at least one breed cluster includes a plurality of emotion detectors. The breed cluster may include a plurality of breeds, where the plurality of breeds may share at least one physical and/or emotional attribute. For example, 544 breeds may be divided into 5 clusters based on various physical features. Additionally, for example, the breeds in each of the clusters may share a physical attribute, such as similar size, tail carriage, ear type, and the like. The emotion detectors may include one or more relationships between one or more emotions and the one or more physical attributes. In some embodiments, a physical attribute may correspond to the posture and/or movement of the pet. The one or more physical attributes may include, high ears, low ears, ears put back, high tail, low tail, wagging tail, and the like. In some embodiments, the one or more relationships may be breed-specific. For example, if the breed is a Labrador Retriever, a low tail carriage may be related to an afraid or an anxious emotion. However, if the breed is a Greyhound, low tail carriage may be related to a happy or relaxed emotion. In some embodiments, the pet may be associated with the at least one breed cluster based on the at least one pet outline, without classifying the at least one pet included in the at least one pet outline as corresponding to at least one pet breed. For example, the method may include analyzing the at least one pet outline to determine an associated at least one breed cluster.

In some embodiments, the method may include detecting, by the one or more processors, one or more emotions of the at least one pet based on the plurality of emotion detectors of the at least one breed cluster. The one or more emotions may include happy, sad, frustrated, curious, afraid or anxious, aggressive and afraid, aggressive without fear, predatory, and conflicted. The detecting may include analyzing the emotion detectors of the at least one breed cluster. In some embodiments, the detecting may include analyzing the pet data to detect one or more emotions. In some embodiments, the detecting may include analyzing numerous emotion detectors, where a particular combination of emotion detectors may indicate a particular emotion. In some embodiments, the detecting may include detecting the one or more emotions for a period of time. For example, an emotion may be detected for several frames, but not for all of the image data. Additionally, or alternatively, more than one emotion may be detected, where each emotion may be detected for a certain period of time corresponding to a certain number of frames.

In some embodiments, detecting the one or more emotions may be performed by a convolutional neural network (CNN) model or a transformer-based model. A combination of the CNN model and the transformer-based model may reduce spatial redundancy, as well as capture complex global dependencies. The CNN model may generate rich spatial features, and the transformer-based model may capture a temporal relationship between such spatial features. The temporal relationship may assist in capturing emotions that may be expressed through actions/body movements in pets. For example, the CNN model may capture actions such as, movement of the pet's tail, running, eating, jumping, and the like through a temporal relationship between the one or more frames, and then the CNN model may translate such actions into one or more emotions.

The method may include displaying, by the one or more processors, the one or more emotions on at least one user interface of a user device (Step 108). For example, the user device may display the emotion (e.g., “happy”) with a visual representation (e.g., a smiley face). In some embodiments, the user may be able to respond to the displayed emotion to indicate whether the user believes that the pet may be experiencing the emotion. Additionally, displaying the one or more emotions may also include displaying at least one emotion confidence level, the at least one pet breed, and/or at least one pet breed confidence level. For example, the method may include determining a confidence level corresponding to the one or more emotions, where the confidence level may indicate the confidence of the emotions determination. Additionally, or alternatively, for example, the method may include determining a confidence level corresponding to the breed, where the confidence level may indicate the confidence of the breed determination. In some embodiments, the machine-learning model may determine the confidence of the emotions and/or breed determination.

The method may include storing, by the one or more processors, the at least one pet and the one or more emotions in one or more data stores. For example, the data stores may be located within the user device and/or located within an external system (e.g., a data store of the system performing the analysis). Additionally, the storing may also include storing details regarding the pet's emotions. For example, the additional details may include information regarding the pet's location (e.g., the pet is outside), weather conditions (e.g., the weather is sunny), posture, and/or movement. In such an example, the information may be collected via user input, GPS data, data collected from wearables, and the like.

In some embodiments, the method may include creating, by the one or more processors, a customized plan for the at least one pet based on the one or more emotions. The customized plan may be created to improve a pet's emotion(s). For example, the customized plan may include more time outside, inside, and the like. In some embodiments, the customized plan may include educational materials describing how the pet owner may recognize the one or more emotions and/or general steps to take to address the one or more emotions. The customized plan may also include other resources for the pet owner. The method may further include displaying, by the one or more processors, the customized plan on the at least one user interface of the user device. Displaying the customized plan may include displaying one or more tasks for the pet to complete.

In some embodiments, the method may include determining, by the one or more processors, at least one recommendation based on the one or more emotions, wherein the at least one recommendation includes at least one physical activity. For example, if the pet has an unhappy emotion, the system may recommend that the pet goes on a 10 minute walk each day. In some embodiments, the at least one recommendation may correspond to a particular pet product (e.g., food, toys, and the like). The method may further include displaying, by the one or more processors, the at least one recommendation on the at least one user interface of the user device.

In some embodiments, the method may include comparing, by the one or more processors, the one or more emotions to at least one previous emotion of the at least one pet. For example, the method may include retrieving at least one stored previous emotion corresponding to the at least one pet. The system may analyze the emotions and the previous emotion(s) to determine similarities and/or differences of the emotions and circumstances surrounding such emotions. The method may further include displaying, by the one or more processors, information corresponding to the comparing on the at least one user interface of the user device. For example, the system may track the pet's emotional state over a period of time and/or provide updates on the pet's progress (e.g., daily, weekly, monthly, and the like).

In some embodiments, the method may include displaying, by the one or more processors, at least one visual dashboard. For example, the visual dashboard may include visual representations of the pet's emotional progress, recommendations for physical activities for the pet, and/or provide real-time feedback to the pet owner.

In some embodiments, the analysis may be offered as a subscription service, where a pet owner may pay a monthly or annual fee to access the tool's features and receive personalize guidance and recommendations. Additionally, or alternatively, the tool may be offered on a pay-per-use basis, where pet owners may pay a fee for each individual use of the tool. In some embodiments, the tool may consult and train vets on how to use and interpret the data generated by the tool. In some embodiments, the tool may refer pet owners to professional services and/or products. In some embodiments, the tool may integrate with other systems, such as electronic health records (dog collars, accelerometers, and the like) and/or telemedicine. In some embodiments, the system may be implemented in different settings, where the tool may analyze the emotions differently depending on the setting (e.g., dog day care, groomers, vet clinics, kennels, and the like). In some embodiments, the system may be integrated into a “smart home,” where pet owners may monitor their dog's emotional wellbeing via a connected ecosystem.

Although FIG. 1 shows example blocks of exemplary method 100, in some implementations, the exemplary method 100 may include additional blocks, fewer blocks, different blocks, or differently arranged blocks than those depicted in FIG. 1. Additionally, or alternatively, two or more of the blocks of the exemplary method 100 may be performed in parallel.

### Exemplary Interface for Determining an Emotion

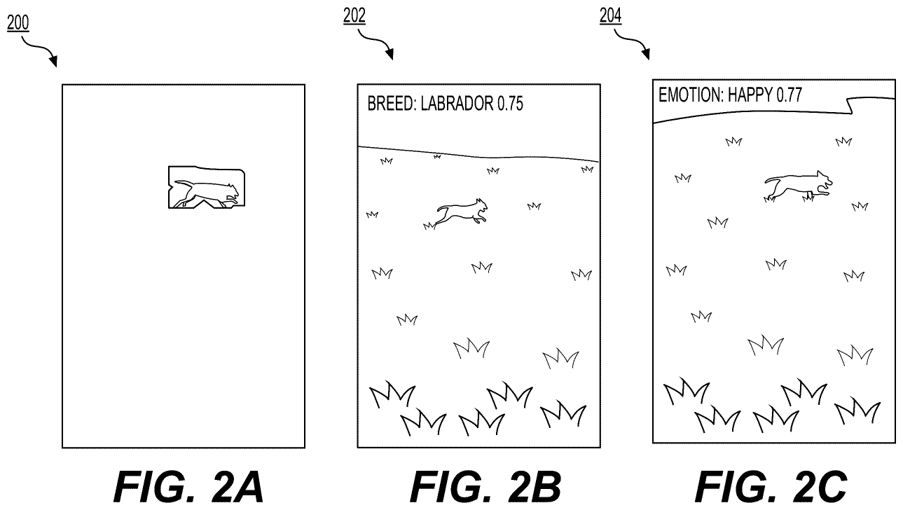

FIGS. 2A-2C depict an example interface for analyzing pet image data to determine an emotion, according to one or more embodiments. FIG. 2A illustrates a frame 200 that may include a pet outline and a mask. A machine-learning model, such as a CNN based model, may be trained to detect the outline of one or more pets in each frame of input video, as well as track each of the one or more pets individually. The pet outline may include one pet and a radius of pixels around the pet. In some embodiments, the radius may include a threshold of distance from the pet in the frame (e.g., a minimum of 3 millimeters from the pet). The detected outline or mask may be dilated to handle model errors and maximize coverage of the pet. The mask may be used to remove the original background and add color (e.g., the same color) to each pixel of the background. Since each unique pet may be tracked in the video, all other pets except the currently tracked pet may become a part of the background. For example, such tracking and masking may enable the creation of separate masked videos for each unique pet in the input video.

FIG. 2B illustrates a frame 202 that may display the identified breed of the pet (e.g., “Breed: Labrador”). In some embodiments, the system may also display a confidence level corresponding to the breed classification (e.g., “0.75”). The machine-learning model, such as a CNN based classification model, may be trained to identify the breed of dog in the input frame. For example, each pet breed may be associated with a breed cluster. Such an association may be trained on data learned by the machine-learning model, or in some cases, the association may be based on manually coded correspondence between the breed cluster and breeds. In some embodiments, outlined pets in each frame of the video may be sent as input to the breed classifier, where each unique dog may be assigned a breed that may have the maximum count across all of the frames. For example, 544 breeds may have been divided into 5 clusters based on various physical features. Creating clusters may allow for the ability to negate the effect of a dog's appearance on the emotion analysis by creating separate emotion detectors for each breed cluster.

FIG. 2C illustrates a frame 204 that may display the detected emotion of the pet (e.g., “Emotion: Happy”). In some embodiments, the system may also display a confidence level corresponding to the detected emotion (e.g., “0.77”). A CNN and Transformer based model may be trained to detect emotion of a dog in videos where the background may have been masked. A combination of the CNN and Transformer based model may help in reducing spatial redundancy and capturing complex global dependencies. The CNN part of the model may generate rich spatial features, and the Transformer part may capture a temporal relationship between such features. In some embodiments, a semi-supervised knowledge distillation training approach may be used to train different models for each breed cluster, which may result in further improving the overall accuracy.

### Exemplary Environment and Exemplary Device

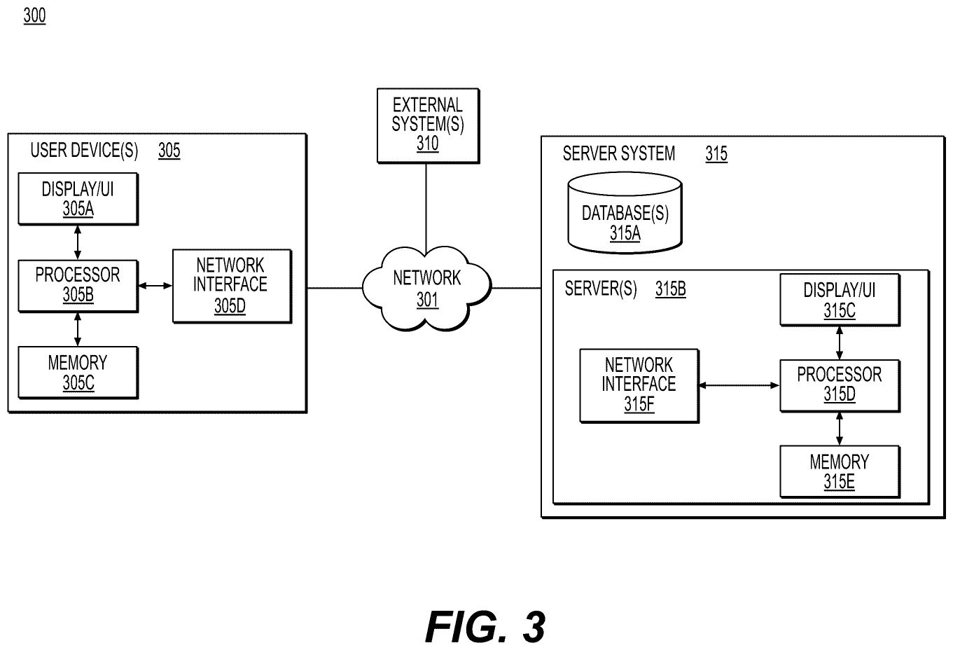

FIG. 3 depicts an exemplary environment 300 that may be utilized with the techniques presented herein. One or more user device(s) 305, one or more external system(s) 310, and one or more server system(s) 315 may communicate across a network 301. As will be discussed in further detail below, one or more server system(s) 315 may communicate with one or more of the other components of the environment 300 across network 301. The one or more user device(s) 305 may be associated with a user.

In some embodiments, the components of the environment 300 are associated with a common entity, e.g., a pet adoption service, a pet breeder, a pet advertiser, a pet services agency, a veterinarian, a clinic, an animal specialist, a research center, a pet owner, or the like. In some embodiments, one or more of the components of the environment is associated with a different entity than another. The systems and devices of the environment 300 may communicate in any arrangement.

The user device 305 may be configured to enable the user to access and/or interact with other systems in the environment 300. For example, the user device 305 may be a computer system such as, for example, a desktop computer, a mobile device, a tablet, etc. In some embodiments, the user device 305 may include one or more electronic application(s), e.g., a program, plugin, browser extension, etc., installed on a memory of the user device 305.

The user device 305 may include a display/user interface (UI) 305A, a processor 305B, a memory 305C, and/or a network interface 305D. The user device 305 may execute, by the processor 305B, an operating system (O/S) and at least one electronic application (each stored in memory 305C). The electronic application may be a desktop program, a browser program, a web client, or a mobile application program (which may also be a browser program in a mobile O/S), an applicant specific program, system control software, system monitoring software, software development tools, or the like. For example, environment 300 may extend information on a web client that may be accessed through a web browser. In some embodiments, the electronic application(s) may be associated with one or more of the other components in the environment 300. The application may manage the memory 305C, such as a database, to transmit streaming data to network 301. The display/UI 305A may be a touch screen or a display with other input systems (e.g., mouse, keyboard, etc.) so that the user(s) may interact with the application and/or the O/S. The network interface 305D may be a TCP/IP network interface for, e.g., Ethernet or wireless communications with the network 301. The processor 305B, while executing the application, may generate data and/or receive user inputs from the display/UI 305A and/or receive/transmit messages to the server system 315, and may further perform one or more operations prior to providing an output to the network 301.

External systems 310 may be, for example, one or more third party and/or auxiliary systems that integrate and/or communicate with the server system 315 in performing various image capturing and/or emotion analyzing tasks. For example, external systems 310 may include one or more services that include storage of pet images (e.g., pet video). Additionally, for example, such pet images may correspond to video of one or more pets. External systems 310 may be in communication with other device(s) or system(s) in the environment 300 over the one or more networks 301. For example, external systems 310 may communicate with the server system 315 via API (application programming interface) access over the one or more networks 301, and also communicate with the user device(s) 305 via web browser access over the one or more networks 301.

In various embodiments, the network 301 may be a wide area network (“WAN”), a local area network (“LAN”), a personal area network (“PAN”), or the like. In some embodiments, network 301 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 315 may include an electronic data system, e.g., a computer-readable memory such as a hard drive, flash drive, disk, etc. In some embodiments, the server system 315 includes and/or interacts with an application programming interface for exchanging data to other systems, e.g., one or more of the other components of the environment.

The server system 315 may include a database 315A and at least one server 315B. The server system 315 may be a computer, system of computers (e.g., rack server(s)), and/or or a cloud service computer system. The server system may store or have access to database 315A (e.g., hosted on a third party server or in memory 315E). The server(s) may include a display/UI 315C, a processor 315D, a memory 315E, and/or a network interface 315F. The display/UI 315C may be a touch screen or a display with other input systems (e.g., mouse, keyboard, etc.) for an operator of the server 315B to control the functions of the server 315B. The server system 315 may execute, by the processor 315D, an operating system (O/S) and at least one instance of a servlet program (each stored in memory 315E).

Although depicted as separate components in FIG. 3, it should be understood that a component or portion of a component in the environment 300 may, in some embodiments, be integrated with or incorporated into one or more other components. For example, a portion of the display 315C may be integrated into the user device 305 or the like. In some embodiments, operations or aspects of one or more of the components discussed above may be distributed amongst one or more other components. Any suitable arrangement and/or integration of the various systems and devices of the environment 300 may be used.

In the previous and following methods, various acts may be described as performed or executed by a component from FIG. 3, such as the server system 315, the user device 305, or components thereof. However, it should be understood that in various embodiments, various components of the environment 300 discussed above may execute instructions or perform acts including the acts discussed above. An act performed by a device may be considered to be performed by a processor, actuator, or the like associated with that device. Further, it should be understood that in various embodiments, various steps may be added, omitted, and/or rearranged in any suitable manner.

In general, any process or operation discussed in this disclosure that is understood to be computer-implementable, such as the processes illustrated in FIGS. 1-2C, may be performed by one or more processors of a computer system, such any of the systems or devices in the environment 300 of FIG. 3, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 3. One or more processors of a computer system may be included in a single computing device or distributed among a plurality of computing devices. A memory of the computer system may include the respective memory of each computing device of the plurality of computing devices.

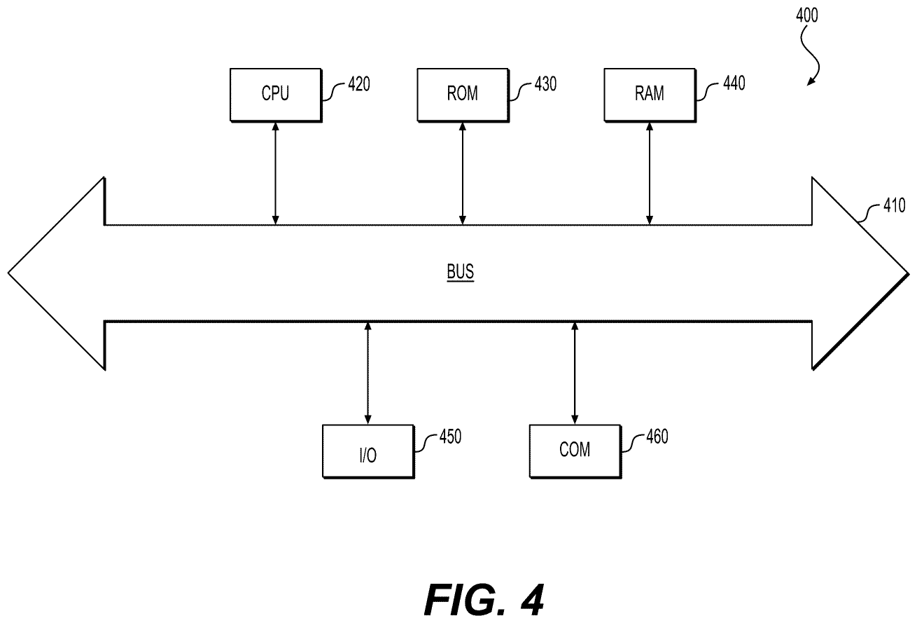

FIG. 4 is a simplified functional block diagram of a computer 400 that may be configured as a device for executing the environments and/or the methods of FIGS. 1-2C, according to exemplary embodiments of the present disclosure. For example, device 400 may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the description herein and the appended drawings, wherein like elements are referred to with the same reference numerals.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for detecting one or more emotions of one or more pets, the method comprising:
receiving, by one or more processors, image data from at least one user device, wherein the image data includes one or more frames;
detecting, by the one or more processors, at least one pet outline that includes at least one pet in the one or more frames;
detecting, by the one or more processors, one or more emotions of the at least one pet based on the at least one pet outline; and
displaying, by the one or more processors, the one or more emotions on at least one user interface of a user device.

2. The computer-implemented method of claim 1, the method further comprising:
classifying, by the one or more processors, the at least one pet included in the at least one pet outline as corresponding to at least one pet breed; and
associating, by the one or more processors, the at least one pet breed with at least one breed cluster, wherein each of the at least one breed cluster includes a plurality of emotion detectors.

3. The computer-implemented method of claim 2, the classifying further comprising:
receiving, by a trained machine-learning model, the at least one pet outline;
analyzing, by the trained machine-learning model, the at least one pet outline to determine at least one physical feature of the at least one pet; and
determining, by the trained machine-learning model, based on the at least one physical feature, that the at least one pet corresponds to the at least one pet breed.

4. The computer-implemented method of claim 2, the method further comprising:
analyzing, by the one or more processors, the at least one pet outline in each of the one or more frames; and
determining, by the one or more processors, that the at least one pet breed occurs a maximum amount of times in the one or more frames.

5. The computer-implemented method of claim 1, wherein the detecting is performed by a convolutional neural network (CNN) model or a transformer-based model.

6. The computer-implemented method of claim 1, wherein the image data includes video data.

7. The computer-implemented method of claim 1, the method further comprising:
dilating, by the one or more processors, the at least one pet outline to maximize coverage of the at least one pet outline.

8. The computer-implemented method of claim 1, the method further comprising:
identifying, by the one or more processors, at least one mask corresponding to a background around the at least one pet outline of the one or more frames;
updating, by the one or more processors, the one or more frames, the updating including utilizing the at least one mask to neutralize the background from the one or more frames; and
creating, by the one or more processors, new image data based on the one or more updated frames.

9. The computer-implemented method of claim 1, the method further comprising:
creating, by the one or more processors, a customized plan for the at least one pet based on the one or more emotions; and
displaying, by the one or more processors, the customized plan on the at least one user interface of the user device.

10. The computer-implemented method of claim 1, the method further comprising:
determining, by the one or more processors, at least one recommendation based on the one or more emotions, wherein the at least one recommendation includes at least one physical activity; and
displaying, by the one or more processors, the at least one recommendation on the at least one user interface of the user device.

11. The computer-implemented method of claim 1, the method further comprising:
storing, by the one or more processors, the at least one pet and the one or more emotions in one or more data stores.

12. The computer-implemented method of claim 1, the method further comprising:
comparing, by the one or more processors, the one or more emotions to at least one previous emotion of the at least one pet; and
displaying, by the one or more processors, information corresponding to the comparing on the at least one user interface of the user device.

13. A computer system for detecting one or more emotions of one or more pets, the computer system comprising:
at least one memory storing instructions; and
at least one processor configured to execute the instructions to perform operations comprising:
receiving image data from at least one user device, wherein the image data includes one or more frames;
detecting at least one pet outline that includes at least one pet in the one or more frames;
detecting one or more emotions of the at least one pet based on the at least one pet outline; and
displaying the one or more emotions on at least one user interface of a user device.

14. The computer system of claim 13, the operations further comprising:
classifying the at least one pet included in the at least one pet outline as corresponding to at least one pet breed; and
associating the at least one pet breed with at least one breed cluster, wherein each of the at least one breed cluster includes a plurality of emotion detectors.

15. The computer system of claim 14, the classifying further comprising:
receiving, by a trained machine-learning model, the at least one pet outline;
analyzing, by the trained machine-learning model, the at least one pet outline to determine at least one physical feature of the at least one pet; and
determining, by the trained machine-learning model, based on the at least one physical feature, that the at least one pet corresponds to the at least one pet breed.

16. The computer system of claim 13, the operations further comprising:
analyzing the at least one pet outline in each of the one or more frames; and
determining that the at least one pet breed occurs a maximum amount of times in the one or more frames.

17. The computer system of claim 13, the operations further comprising:
dilating the at least one pet outline to maximize coverage of the at least one pet outline.

18. The computer system of claim 13, the operations further comprising:
identifying at least one mask corresponding to a background around the at least one pet outline of the one or more frames;
updating the one or more frames, the updating including utilizing the at least one mask to neutralize the background from the one or more frames; and
creating new image data based on the one or more updated frames.

19. A non-transitory computer-readable medium storing instructions that, when executed by a processor, cause the processor to perform operations for detecting one or more emotions of one or more pets, the operations comprising:
receiving image data from at least one user device, wherein the image data includes one or more frames;
detecting at least one pet outline that includes at least one pet in the one or more frames;
detecting one or more emotions of the at least one pet based on the at least one pet outline; and
displaying the one or more emotions on at least one user interface of a user device.

20. The non-transitory computer-readable medium of claim 19, the operations further comprising:
comparing the one or more emotions to at least one previous emotion of the at least one pet; and
displaying information corresponding to the comparing on the at least one user interface of the user device.
